(19) United States
(12) Patent Application Publication
(10) Pub. No.: US 2023/0188241 A1
(43) Pub. Date: Jun. 15, 2023

(54) HOLDER FOR MOUNTING OPTICAL COMPONENTS AND AN OPTICAL SUBASSEMBLY IMPLEMENTING SAME

(71) Applicant: Applied Optoelectronics, Inc., Sugar Land, TX (US)

(72) Inventors: Kai-Sheng LIN, Sugar Land, TX (US); Hao-Chiang CHENG, Houston, TX (US); Ziliang CAI, Richmond, TX (US)

(21) Appl. No.: 17/551,488

(22) Filed: Dec. 15, 2021

(51) Int. Cl. H04J 14/02; H04B 10/40

(52) U.S. Cl. CPC H04J 14/0213; H04B 10/40

(57) ABSTRACT

The present disclosure is generally directed to a holder that can be used to couple to and optically align an optical component with, for instance, an associated light path to launch or receive optical channel wavelengths along the same. The holder preferably includes a receptacle to couple to the optical component and a mounting section enables the holder to be securely coupled to a substrate in a manner that minimizes or otherwise reduces introducing component shift and resulting optical misalignment.

### TECHNICAL FIELD

The present disclosure generally relates to optical communications, and more specifically, to a holder for mounting and aligning an optical component with a light path within an optical subassembly module.

### BACKGROUND

Optical transceivers are used to transmit and receive optical signals for various applications including, without limitation, internet data centers, cable TV broadband, and fiber to the home (FTTH) applications. Optical transceivers provide higher speeds and bandwidth over longer distances, for example, as compared to transmission over copper cables. The desire to provide higher transmit/receive speeds in increasingly space-constrained optical transceiver modules has presented challenges, for instance, with respect to establishing and maintaining proper orientation and alignment of optical components during manufacturing.

Optical transceivers can include one or more transmitter optical subassemblies (TOSAs) and receiver optical subassemblies (ROSAs) for the purpose of transmitting and receiving optical signals. Optical components of TOSAs and/or ROSAs may be securely attached to a housing/substrate at predefined positions relative to each other to ensure nominal optical coupling and power. For instance, components of a TOSA such as a laser assembly, or of a ROSA such as a photodetector, may be attached to a substrate by way of a submount and aligned relative to associated components/light paths. In some cases, such submounts can be displaced/moved during alignment processes (such as active alignment processes) to ensure nominal optical coupling between an optical component mounted thereon and an associated light path. Securing the submount to the substrate after such alignment can include utilizing an adhesive, such as an ultraviolet (UV)-curing epoxy, and/or a fixation member such as a screw/bolt. However, post-alignment activities such as securing the submount to the substrate can result in component shift. Misalignment/shift of a submount by even a few microns can substantially reduce optical coupling/performance, and can ultimately reduce component yield.

### BRIEF DESCRIPTION OF THE DRAWINGS

The accompanying drawings are provided to illustrate some, but not all, embodiments of the present disclosure to facilitate the understanding of the present disclosure. The drawings are parts of the present disclosure. The illustrative embodiments and the descriptions are for explaining the principles of the present disclosure and are not intended to limit the scope of the present disclosure. The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a block diagram of a multi-channel optical transceiver in accordance with aspects of the present disclosure.

FIG. 2A shows a perspective view of an example holder that is configured to couple to and optically align an optical component with an associated optical light path, in accordance with aspects of the present disclosure.

FIG. 2B shows a cross sectional view of the holder taken along line B-B of FIG. 2A, in accordance with aspects of the present disclosure.

FIG. 3A is a perspective view of the holder of FIG. 2A in isolation, in accordance with aspects of the present disclosure.

FIG. 3B shows an example top view of the holder of FIG. 3A, in accordance with aspects of the present disclosure.

FIG. 3C shows an example bottom view of the holder of FIG. 3A, in accordance with aspects of the present disclosure.

FIG. 3D shows an example side view of the holder of FIG. 3A, in accordance with aspects of the present disclosure.

FIG. 3E shows another example side view of the holder of FIG. 3A, in accordance with aspects of the present disclosure.

### DETAILED DESCRIPTION

As previously discussed, optical components within optical subassemblies can become misaligned during manufacturing processes, such as when submounts are fixedly attached to a substrate following an alignment procedure/routine. Even a relatively small misalignment (e.g., a few microns) between optical components within a TOSA or ROSA can significantly reduce optical performance.

In view of the above, the present disclosure is generally directed to a holder that can be used to couple to and optically align an optical component with, for instance, an associated optical light path to launch or receive optical channel wavelengths along the same. The holder preferably includes a receptacle to couple to the optical component and a mounting section enables the holder to be securely coupled to a substrate in a manner that minimizes or otherwise reduces introducing component shift and resulting optical misalignment.

In one example, a holder consistent with the present disclosure includes a base that defines a receptacle to couple to an optical component and optically align the optical component with a light path. The holder further preferably provides a first flange member extending from the base that defines a mounting section. The mounting section of the first flange member preferably defines a mounting slot that is configured to align with a corresponding aperture provided by a substrate or other structure within an optical subassembly. The base, receptacle, and first flange member are preferably formed from a single, monolithic piece of material such as a metal.

The mounting slot is preferably configured to allow insertion of a first fixation member into the aperture and provide an engagement surface whereby the first fixation member can supply a holding force against the mounting slot to securely couple the base to the optical subassembly module. The first flange member preferably includes a recess/notch disposed adjacent the receptacle to allow for the mounting section to “flex” relative to the portion of the base that defines the receptacle in order to minimize/reduce the potential for the holding force supplied by the first fixation member to cause displacement/shift of the receptacle, and thus by extension, misalignment of the optical component mounted/coupled thereto.

Preferably, the holder includes the first flange member and a second flange member, with the first and second flange members extending from the base in opposite directions. The second flange member can include a mounting section that has a similar configuration to that of the mounting section of the first flange member including a mounting slot for receiving a second fixation member, and preferably allows for the second fixation member to supply a holding force against the second flange member. More preferably, the first flange member and the second flange member have an identical profile/configuration and are mirror images of each other. Accordingly, the holder can be securely coupled to a substrate via the holding forces supplied by the first and second fixation members in a manner that reduces or otherwise eliminates the potential for component shift and optical misalignment.

As used herein, “channel wavelengths” refer to the wavelengths associated with optical channels and may include a specified wavelength band around a center wavelength. In one example, the channel wavelengths may be defined by an International Telecommunication (ITU) standard such as the ITU-T dense wavelength division multiplexing (DWDM) grid or course wavelength division multiplexing (CWDM).

The term “coupled” as used herein refers to any connection, coupling, link or the like and “optically coupled” refers to coupling such that light from one element is imparted to another element. Such “coupled” devices are not necessarily directly connected to one another and may be separated by intermediate components or devices that may manipulate or modify such signals. On the other hand, the term “direct optical coupling” refers to an optical coupling via an optical path between two elements that does not include such intermediate components or devices, e.g., a mirror, waveguide, and so on, or bends/turns along the optical path between two elements.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the stated/target characteristic. To provide one non-limiting numerical example to quantify “substantially,” minor variation may cause a deviation of up to and including ±5% from a particular stated quality/characteristic unless otherwise provided by the present disclosure.

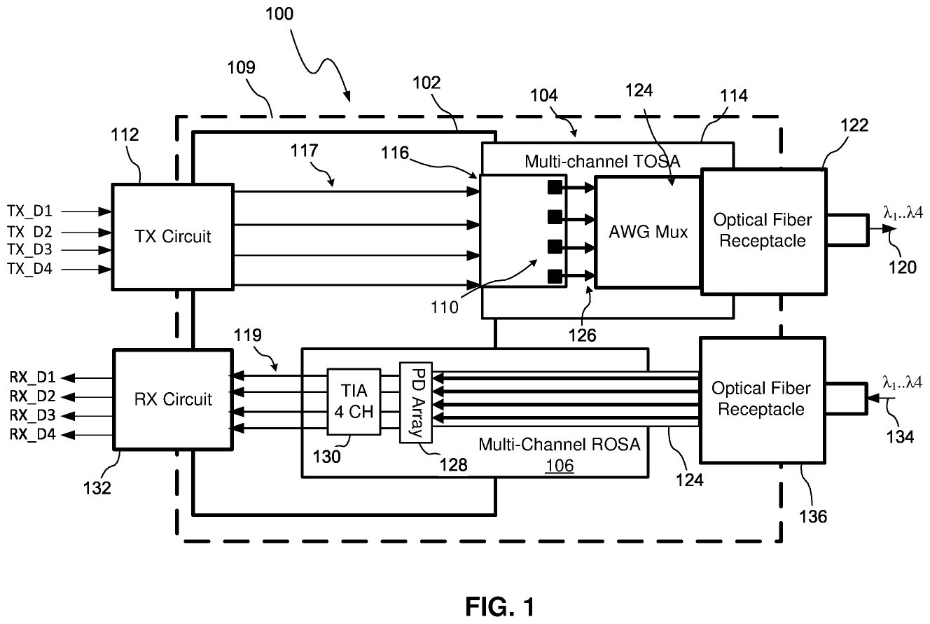

Referring to FIG. 1, an optical transceiver 100, consistent with aspects of the present disclosure, is shown and described. In this example, the optical transceiver 100 includes a multi-channel transmitter optical subassembly (TOSA) arrangement 104 and a multi-channel receiver optical subassembly (ROSA) arrangement 106 coupled to a substrate 102, which may also be referred to as an optical module substrate. The substrate 102 may comprise, for example, a printed circuit board (PCB) or PCB assembly (PCBA). The substrate 102 may be configured to be “pluggable” for insertion into an optical transceiver cage 109.

In the example shown, the optical transceiver 100 transmits and receives four (4) channels using four different channel wavelengths (λ1, λ2, λ3, λ4) via the multi-channel TOSA arrangement 104 and the multi-channel ROSA arrangement 106, respectively, and may be capable of transmission rates of at least about 25 Gbps per channel. In one example, the channel wavelengths λ1, λ2, λ3, λ4 may be 1270 nm, 1290 nm, 1310 nm, and 1330 nm, respectively. Other channel wavelengths are within the scope of this disclosure including those associated with local area network (LAN) wavelength division multiplexing (WDM). The optical transceiver 100 may also be capable of transmission distances of 2 km to at least about 10 km. The optical transceiver 100 may be used, for example, in internet data center applications or fiber to the home (FTTH) applications. Although the following aspects and examples show and describe a 4-channel optical transceiver, this disclosure is not limited in this regard. For example, the present disclosure is equally applicable to 2, 6, or 8-channel configurations.

In more detail, the multi-channel TOSA arrangement 104 includes a TOSA housing 114 with a plurality of sidewalls that define a cavity (not shown). The cavity includes a plurality of laser arrangements 110 disposed therein, with each laser arrangement including a holder consistent with the present disclosure to securely hold and align the laser arrangements 110, which will be discussed in greater detail below.

Each laser arrangement of the plurality of laser arrangements 110 can be configured to transmit optical signals having different associated channel wavelengths. Each laser arrangement may include passive and/or active optical components such as a laser diode (LD), monitor photodiode (MPD), laser diode driver (LDD), and so on. Additional components comprising each laser arrangement include filters, optical isolators, filtering capacitors, and so on.

To drive the plurality of laser arrangements 110, the optical transceiver 100 includes a transmit connecting circuit 112 to provide electrical connections to the plurality of laser arrangements 110 within the housing 114. The transmit connecting circuit 112 may be configured to receive driving signals (e.g., TX_D1 to TX_D4) from, for example, circuitry within the optical transceiver cage 109. The housing 114 may be optionally hermetically sealed to prevent ingress of foreign material, e.g., dust and debris. In the example of FIG. 1, a plurality of transmit (TX) traces 117 (or electrically conductive paths) may be patterned on at least one surface of the substrate 102 and are electrically coupled with a feedthrough device 116 of the TOSA housing 114 to bring the transmit connecting circuit 112 into electrical communication with the plurality of laser arrangements 110, and thus, electrically interconnect the transmit connecting circuit 112 with the multi-channel TOSA arrangement 104. The feedthrough device 116 may comprise, for instance, ceramic, metal, or any other suitable material.

In operation, the multi-channel TOSA arrangement 104 may then receive driving signals (e.g., TX_D1 to TX_D4), and in response thereto, generates and launches multiplexed channel wavelengths on to an output waveguide 120 such as a transmit optical fiber. The plurality of laser assemblies 110 can be configured to launch/emit channel wavelengths via an associated light path of a plurality of light paths 126. Each of the plurality of light paths 126 can be provided by a waveguide such as an optical fiber. The launched/emitted channel wavelengths may be combined based on a multiplexing device 124. The multiplexing device 124 can include a plurality of input ports, with each input port being optically aligned with an associated light path of the plurality of light paths 126. The multiplexing device 124 can be configured to receive emitted channel wavelengths via the plurality of light paths 126 from the plurality of laser assemblies 110 and output a signal carrying the multiplexed channel wavelengths on to the output waveguide 120 by way of optical fiber receptacle 122.

Continuing on, the multi-channel ROSA arrangement 106 includes a demultiplexing device 124, e.g., an arrayed waveguide grating (AWG), a photodiode (PD) array 128, and an amplification circuitry 130, e.g., a transimpedance amplifier (TIA). An input port of the demultiplexing device 124 may be optically coupled with a receive waveguide 134, e.g., an optical fiber, by way of an optical fiber receptacle 136. An output port of the demultiplexing device 124 may be configured to output separated channel wavelengths on to the PD array 128. The PD array 128 may then output proportional electrical signals to the TIA 130, which then may be amplified and otherwise conditioned. The PD array 128 and the transimpedance amplifier 130 detect and convert optical signals received from the fiber array 133 into electrical data signals (RX_D1 to RX_D4) that are output via the receive connecting circuit 132. In operation, the PD array 128 may then output electrical signals carrying a representation of the received channel wavelengths to a receive connecting circuit 132 by way of conductive traces 119 (which may be referred to as conductive paths).

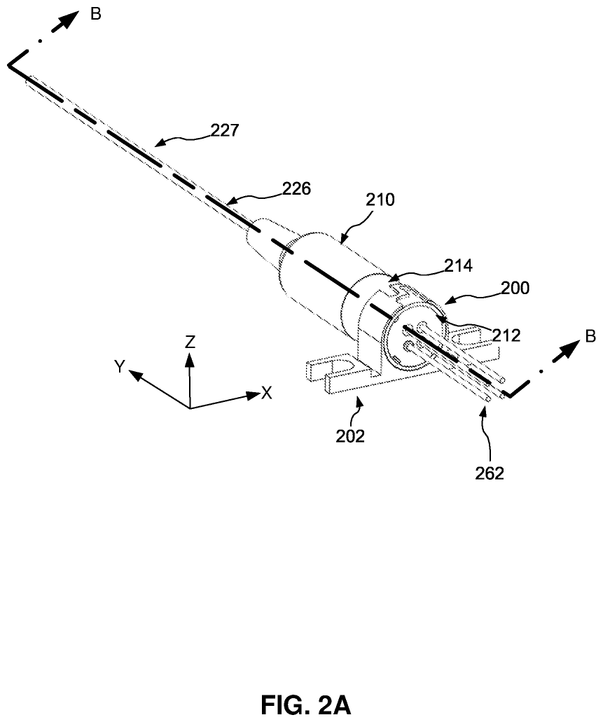

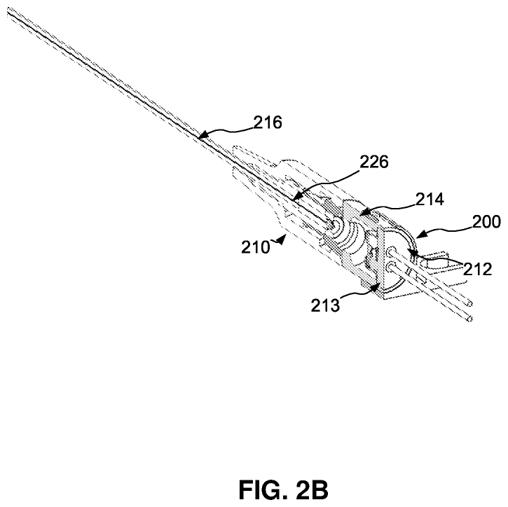

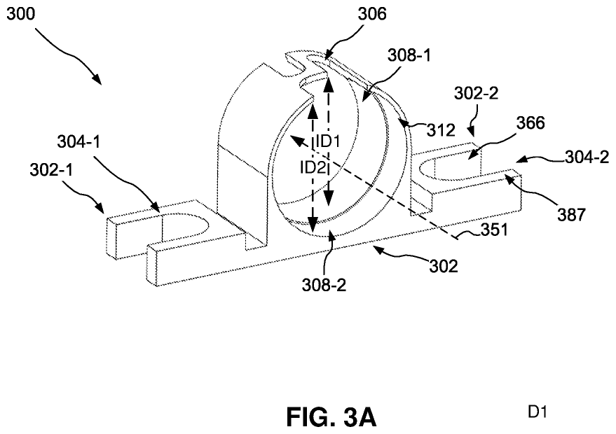

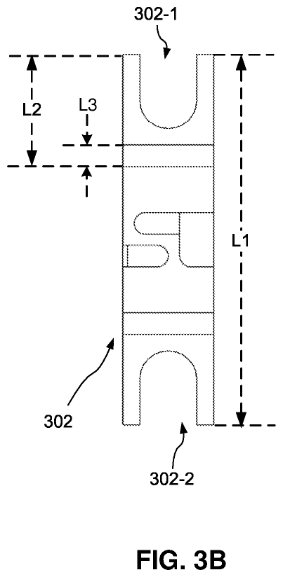

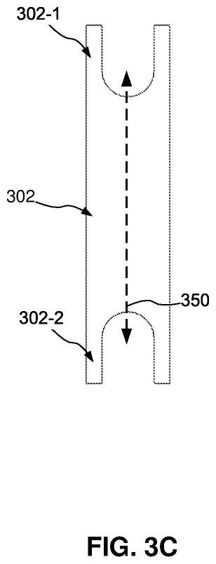

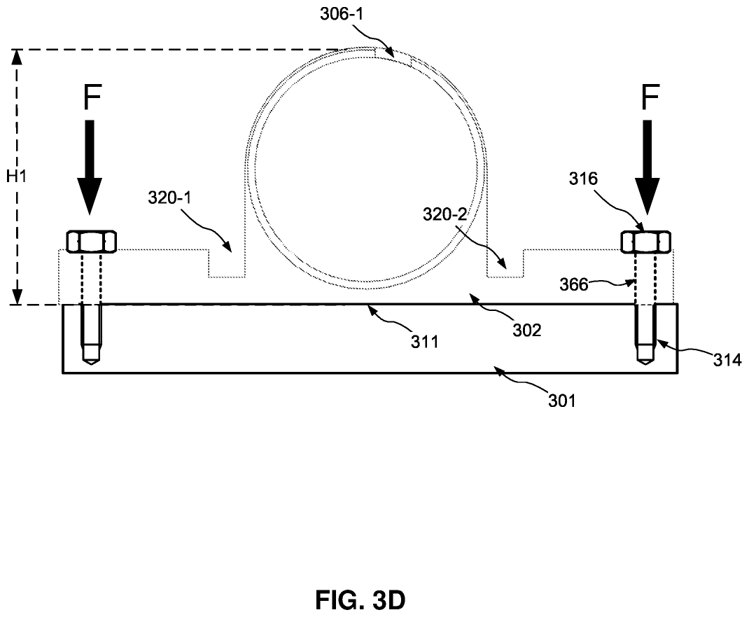

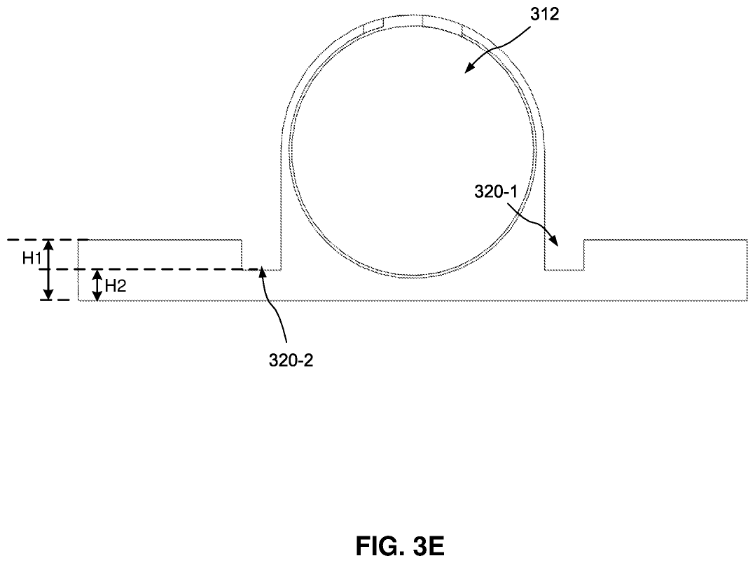

Referring to FIGS. 2A-2B, an example holder 200 consistent with aspects of the present disclosure is shown. The holder 200 preferably includes a base 202 that is configured to mount/couple to a surface within an optical subassembly, such as a surface on the optical subassembly module 301 as shown in FIG. 3D.

The holder 200 further preferably includes a receptacle 212 for coupling to an optical component, such as the optical component 210. The optical component 210 can be configured as a TO laser assembly, and more preferably, as a coaxial TO laser assembly, such as shown.

The receptacle 212 is preferably implemented as a through hole to allow the optical component 210 to extend therethrough. In the example of FIG. 2A, this includes a first end 262 (e.g., implemented as electrical conductors/leads in the example of FIG. 2A) of the optical component 210 extending from the receptacle 212 in a first direction and a second end 264 (e.g., implemented as a TO housing) extending from the receptacle 212 in a second direction, with the first and second directions being opposite.

In one example, an optical transceiver can include one or a plurality of holders implemented as the holder 200. For example, the optical transceiver 100 of FIG. 1 can include a plurality of holders that each mount and align an associated laser arrangement of the plurality of laser arrangements 110 with a corresponding light path of the plurality of light paths 126.

Preferably, the receptacle 212 can be configured to receive the optical component 210 along an insertion path, e.g., insertion path 351 as shown in FIG. 3A, as discussed in further detail below. The receptacle 212 can be configured to form a friction/interference fit with the optical component 210, when the same is inserted into the receptacle 212 along the insertion path 351.

Referring to FIGS. 3A-3E, an example holder 300 consistent with the present disclosure is shown in isolation. The holder 300 can be configured substantially similar to the holder 200 of FIGS. 2A-2B, the aspects and features of which are equally applicable to the holder 300 and will not be repeated for brevity.

As shown, the holder 300 preferably includes a base 302. The base 302 may also be referred to herein as a body. The base 302 is preferably formed from a metal such as stainless steel, although other materials are within the scope of this disclosure. The base 302 preferably defines a mating surface 311 (See FIG. 3D) for coupling/mounting to a surface of an optical subassembly 301.

A receptacle 312 preferably extends from the base 302 to an overall height H1 (See FIG. 3d). The overall height H1 is preferably in a range of 6 to 8 millimeters (mm). More preferably, the receptacle extends from the base 302 at a midpoint of the base 302, such as shown in FIG. 3A. Preferably, the receptacle 312 has an arcuate profile. More preferably, the overall thickness of the sidewalls forming the receptacle 312 varies to provide a spring-like mechanism for insertion of an optical component via notch 306, as discussed in further detail below. In one example, the receptacle 312 provides an extension garter spring that exerts inward radial forces. Preferably, the minimum thickness of the sidewall forming the receptacle 312 is in a range of 0.2 to 0.3 mm.

The receptacle 312 preferably defines a cavity for receiving an optical component, e.g., the optical component 210 of FIG. 2A, along insertion path 351. The cavity of the receptacle 312 can have a cylindrical profile such as shown, although other shapes/profiles are within the scope of this disclosure.

The cavity of the receptacle 312 can be collectively defined by a first insertion region 308-1 and a second insertion region 308-2. The first insertion region 308-1 and the second insertion region 308-2 are preferably disposed concentrically along the insertion path 351 and are in communication with each other to allow for insertion of an optical component. The first insertion region 308-1 preferably has an inner diameter ID1 and the second insertion region 308-2 preferably has an inner diameter ID2. The inner diameter ID1 of the first region 308-1 is preferably less than the inner diameter ID2 of the second region 308-2. 7. In one example, the inner diameter ID1 is in a range of 3.0 to 3.1 millimeters, and the second inner diameter ID2 is in a range of 3.1 to 3.2 millimeters. Accordingly, an optical component, such as optical component 210, can be inserted into the receptacle 312 along insertion path 351 to a predetermined position/depth. Preferably, the insertion path 351 causes the optical component to first be disposed in the second region 308-2 followed by the first region 308-1. Preferably, the predetermined position includes at least a first portion of the optical component 210 within the first region 308-1 and a second portion of the optical component 210 in the second region 308-2.

More preferably, the second portion of the optical component within the second region 308-2 of the receptacle 312 is an electrical interface region of the optical component. For instance, and as shown in FIG. 2B, the electrical interface region of the optical component 210 is implemented as a TO header 213. Preferably, the TO header 213 is disposed within the second region 308-2. As discussed above, the inner diameter ID2 of the second region 308-2 can be greater than the inner diameter ID1 of the first region 308-1.

This can result in the first region 308-1 being configured to supply a first compressive force to the first portion of the optical component, and the second region 308-2 being configured to supply a second compressive force to the second portion of the optical component. Preferably, the first compressive force is in a range of 8 to 10 Newtons (N) and the second compressive force is in a range of 6 to 8 N. The first region 308-1 may therefore be described as providing a relatively tight-fit while the second region 308-2 may be described as providing a relatively loose fit.

The inner diameter ID2 of the second region 308-2 advantageously reduces an amount of force supplied by inner surfaces of the receptacle 212/312 that define the second region 308-2 to the TO header 213 when forming a friction fit. This can avoid damage to the TO header 213 and/or shift/displacement of the TO header 213 when coupled/mounted to a holder consistent with the present disclosure.

On the other hand, the first region 308-1 provides the first compressive force to securely couple the first portion of the optical component into the receptacle 212/312. For instance, and as shown in FIG. 2B, sidewalls defining the receptacle 212 can supply the first compressive force to a housing portion 214 of the optical component 210 to securely couple to the same.

Returning to FIGS. 3A-3E, the receptacle 312 further preferably includes a notched region 306. The notched region 306 can be configured to provide a spring-like mechanism to allow insertion of the optical component to expand/widen the receptacle 312 during insertion, and to provide the first and second compressive forces as discussed above. The notched region 306 can also be used to visually indicate an orientation for the holder 300. Thus, a technician can utilize the notched region 306 to identify which side of the receptacle 312 has the first region 308-1 relative to the side having the second region 308-2 during insertion of an optical component.

The body 302 further preferably defines a first flange member 302-1 and a second flange member 302-2, with the first flange member 302-1 extending opposite the second flange member 302-2. The receptacle 312 is preferably disposed between the first flange member 302-1 and the second flange member 302-2.

The first flange member 302-1 preferably defines a first mounting section 304-1, and the second flange member 302-2 preferably defines a second mounting section 304-2. The first flange member 302-1 and the second flange member 302-2 preferably include an identical configuration and can form a mirror image of each other. Preferably, each mounting section of the first flange member 302-1 and second flange member 302-2 provide a mounting slot, e.g., mounting slot 366, to allow for insertion of a fixation member. Each mounting slot can include a u-shaped profile, such as shown.

For example, and as more clearly shown in FIG. 3D, a fixation member 316 such as a screw or bolt can be disposed within the mounting slot 366. The mounting slot 366 can be disposed at a predetermined position along the base 302 to align with an aperture provided by an optical subassembly, such as aperture 314. The aperture 314 can be a threaded hole, for example. Accordingly, the fixation member 316 can be disposed within the mounting slot 366 and supply a holding force F against an outer surface 387 (see FIG. 3A) that defines the slot 366. The outer surface 387 may also be referred to as an engagement surface.

Preferably, the first flange member 302-1 includes a first recess 320-1 disposed adjacent the receptacle 312 and the second flange member 302-2 includes a second recess 320-2 disposed adjacent the receptacle. The first recess 320-1 and the second recess 320-2 may also be referred to herein as stress relief recesses or stress relief slots. As shown more clearly in FIG. 3E, each of the flange members includes an overall height H1 that transitions/tapers to an overall height H2, with the overall height H1 being greater than the overall height H2 to provide the respective first and second recesses 320-1, 320-2.

The overall length L1 of the base 302 is preferably in a range of 15 to 20 mm. The overall length L2 of each flange member is preferably in a range of 4 to 6 mm. More preferably, the first and second flange members 302-1 and 302-2 include an overall length that is equal. Preferably, the overall length L3 of the first recess 320-1 and the second recess 320-2 measures in a range of 3 to 4 mm. More preferably, the overall length L3 of each respective recess accounts for about 1-20% of the overall length L2 that the flange members extend from the receptacle 312.

The first recess 320-1 and the second recess 320-2 are preferably configured to introduce a weak point along the base 302. The weak point is preferably configured to allow for the flange members to “flex” relative to the receptacle 312 when a holding force F is supplied by a fixation to the first and/or second flange members 302-1, 302-2 (See FIG. 3D). Thus, the mating surface 311 of the base 302 preferably maintains connection/engagement with an outer surface of the optical subassembly module 301 when a fixation member is inserted, and supplies a holding force F, against the first and/or second flange members 302-1, 302-2 (See FIG. 3D). Accordingly, the base 302 can be securely coupled to the optical subassembly module 301 in a manner that reduces or otherwise eliminates component shift.

After securely coupling the base 302 to the optical subassembly module 301, receptacle 312 preferably securely holds/maintains the optical component 210 at a predetermined orientation along the X, Y and Z axis (see FIG. 2A). Accordingly, alignment about the X and Y axis may be achieved simply by disposing and (securely) coupling a holder consistent with the present disclosure at a desired position on an optical subassembly. An optical component can be inserted into a receptacle of the holder before or after securely coupling the holder to the optical subassembly.

In accordance with an aspect of the present disclosure a holder for coupling an optical component to an optical subassembly module is disclosed. The holder comprising a base defining a receptacle to couple to the optical component and optically align the optical component with a light path, a first flange member extending from the base and defining a mounting slot to align with a corresponding aperture provided by the optical subassembly, the mounting slot configured to allow insertion of a fixation member into the aperture to supply a holding force against the mounting slot to securely couple the base to the optical subassembly module, wherein the first flange member includes a stress relief slot disposed between the mounting slot and the receptacle to maintain optical alignment of the optical component with the light path when the fixation member supplies the holding force against the mounting slot.

In accordance with an aspect of the present disclosure, a holder for coupling an optical component to an optical subassembly module, the holder comprising a base defining a receptacle to couple to the optical component and optically align the optical component with a light path, a first flange member extending from the base and defining a mounting slot to align with a corresponding aperture provided by the optical subassembly, the mounting slot configured to allow insertion of a fixation member into the aperture to supply a holding force against the mounting slot to securely couple the base to the optical subassembly module, and wherein the receptacle defines a cavity, the cavity having a first region with a first inner diameter ID1 and a second region with a second inner diameter ID2, wherein the first inner diameter ID1 is different than the second inner diameter ID2.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure, which is not to be limited except by the following claims.

What is claimed is:

1. A holder for coupling an optical component to an optical subassembly module, the holder comprising:
a base defining a receptacle to couple to the optical component and optically align the optical component with a light path;
a first flange member extending from the base and defining a mounting slot to align with a corresponding aperture provided by the optical subassembly, the mounting slot configured to allow insertion of a fixation member into the aperture to supply a holding force against the mounting slot to securely couple the base to the optical subassembly module;
wherein the first flange member includes a stress relief slot disposed between the mounting slot and the receptacle to maintain optical alignment of the optical component with the light path when the fixation member supplies the holding force against the mounting slot.

2. The holder of claim 1, wherein the first flange member has a first height H1 that transitions to a second height H2, with the second height H2 being less than the first height H1, and a portion of the first flange with the second height H2 defines the stress relief slot.

3. The holder of claim 1, wherein the receptacle defines a cavity, the cavity having a first region with a first inner diameter ID1 and a second region with a second inner diameter ID2, wherein the first inner diameter ID1 is different than the second inner diameter ID2.

4. The holder of claim 3, wherein the first inner diameter D1 is less than the second inner diameter D2.

5. The holder of claim 3, wherein the receptacle is configured to supply a first compressive force to the optical component based on the first inner diameter ID1 of the first region and a second compressive force to the optical component based on the second inner diameter ID2 of the second region, and wherein the first compressive force is greater than the second compressive force.

6. The holder of claim 3, wherein the first compressive force is in a range of 8 to 10 Newtons (N).

7. The holder of claim 3, wherein the first inner diameter ID1 is in a range of 3.0 to 3.1 millimeters, and the second inner diameter ID2 is in a range of 3.1 to 3.2 millimeters.

8. The holder of claim 3, wherein the cavity has a cylindrical profile.

9. The holder of claim 1, wherein the receptacle is configured to couple to the optical component via friction fit.

10. A holder for coupling an optical component to an optical subassembly module, the holder comprising:
a base defining a receptacle to couple to the optical component and optically align the optical component with a light path;
a first flange member extending from the base and defining a mounting slot to align with a corresponding aperture provided by the optical subassembly, the mounting slot configured to allow insertion of a fixation member into the aperture to supply a holding force against the mounting slot to securely couple the base to the optical subassembly module; and
wherein the receptacle defines a cavity, the cavity having a first region with a first inner diameter ID1 and a second region with a second inner diameter ID2, wherein the first inner diameter ID1 is different than the second inner diameter ID2.

11. The holder of claim 10, wherein the first inner diameter D1 is less than the second inner diameter D2.

12. The holder of claim 10, wherein the receptacle is configured to supply a first compressive force to the optical component based on the first inner diameter ID1 of the first region and a second compressive force to the optical component based on the second inner diameter ID2 of the second region, and wherein the first compressive force is greater than the second compressive force.

13. The holder of claim 10, wherein the first compressive force is in a range of 8 to 10 Newtons (N).

14. The holder of claim 10, wherein the first inner diameter ID1 is in a range of 3.0 to 3.1 millimeters, and the second inner diameter ID2 is in a range of 3.1 to 3.2 millimeters.

15. The holder of claim 10, wherein the cavity has a cylindrical profile.

16. The holder of claim 10, wherein the receptacle is configured to couple to the optical component via friction fit.
